(19) United States
(12) Patent Application Publication
(10) Pub. No.: US 2026/0112271 A1
(43) Pub. Date: Apr. 23, 2026

(54) SYSTEM AND METHOD FOR VEHICLE PARKING COMPLIANCE

(71) Applicant: Torc Robotics, Inc., Blacksburg, VA (US)

(72) Inventors: Simon Schaefer, Stuttgart (DE); Carlo Elwinger, Maulbronn (DE); Janine Guenther, Leinfelden (DE)

(21) Appl. No.: 18/919,790

(22) Filed: Oct. 18, 2024

(51) Int. Cl. G08G 1/14

(52) U.S. Cl. CPC G08G 1/146

(57) ABSTRACT

A system for vehicle parking compliance is provided. The system includes one or more sensors associated with a vehicle. The one or more sensors are configured to detect an environment surrounding the vehicle. The system includes a processing device in communication with the one or more sensors. The processing device is configured to execute instructions stored in a memory to perform operations that include generating a map of the environment based on signals received from the one or more sensors, identifying a space within the environment capable of accommodating the vehicle during a parking operation, and determining if in a parked position in the space, the vehicle violates one or more vehicle parking regulations.

### TECHNICAL FIELD

The field of the disclosure relates to vehicle parking compliance and, in particular, to a system that ensures a space found for parking of a vehicle is in compliance with local regulations, including distances between vehicles and distances from intersections to improve the driving experience of other vehicles.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

In some instances, autonomous vehicles (as well as semi-autonomous) can include parking assistance systems that can park a vehicle in a designated space without or with minimal driver input. For traditional vehicles (i.e., not autonomous), the driver of the vehicle handles the entire parking process. In both instances, the focus is on selecting a spot that is capable of accommodating the vehicle. However, despite being sufficiently sized to accommodate the vehicle, parking the vehicle in such space may still break certain traffic rules. For example, the parked vehicle can block other vehicles due to the driver's negligence. This can be particularly problematic near intersections, where certain vehicles (e.g., passenger vehicles, trucks, trucks with trailers, emergency vehicles, garbage trucks, or the like) with a large turning radius may find it difficult or impossible to make turns if other vehicles are parked too close to the intersection.

Accordingly, there exists a need for a system and a method of vehicle parking compliance that ensures the chosen parking space does not violate parking regulations. These and other needs are met by the exemplary system for vehicle parking compliance discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for vehicle parking compliance is provided. The system includes one or more sensors associated with a vehicle. The one or more sensors are configured to detect an environment surrounding the vehicle. The system includes a processing device in communication with the one or more sensors. The processing device is configured to execute instructions stored in a memory to perform operations that include generating a map of the environment based on signals received from the one or more sensors. The operations include identifying a space within the environment capable of accommodating the vehicle during a parking operation. The operations include determining if in a parked position in the space, the vehicle violates one or more vehicle parking regulations.

The system includes a database configured to electronically store the one or more vehicle parking regulations associated with the environment. The operations include updating the one or more vehicle parking regulations based on changes to the one or more vehicle parking regulations (e.g., based on ongoing updates in the industry and in local jurisdictions). In some embodiments, the database can be an online database in communication with the system, and the system can request up-to-date information from the online database regarding the one or more vehicle parking regulations (e.g., as the vehicle travels from environment to environment to adjust for changes in regulations in jurisdictions, as the vehicle enters or is detected to enter into a parking operation, or the like). In some embodiments, the one or more vehicle parking regulations can include a minimum distance from a corner of an intersection. In some embodiments, the one or more vehicle parking regulations can include an unlawful obstruction of other vehicles. In some embodiments, the one or more vehicle parking regulations can include an unlawful obstruction for pedestrians. In some embodiments, the one or more vehicle parking regulations can include a no parking zone.

In some embodiments, the map can be a two-dimensional (2D) digital map of the environment. In some embodiments, the map is a three-dimensional (3D) digital map of the environment. In some embodiments, generating the map of the environment can include continuously generating and updating the map of the environment as the vehicle travels through the environment. Identifying a space within the environment can include determining a minimum space requirement between the vehicle and (i) surrounding vehicles and/or (ii) an intersection corner.

In some embodiments, the one or more sensors can include, e.g., LiDAR, a camera, radar, an ultrasonic sensor, combinations thereof, or the like. However, it should be understood any sensors known in the industry can be used. If in the parked position in the space the vehicle does not violate the one or more vehicle parking regulations, the operations can include permitting the vehicle to park in the space. In some embodiments, the system can include a user interface including a display. In such embodiments, if in the parked position in the space the vehicle does not violate the one or more vehicle parking regulations, the operations can include generating a parking permission alert on the display of the user interface. In such embodiments, if in the parked position in the space the vehicle violates the one or more vehicle parking regulations, the operations can include generating an alert on the display of the user interface regarding a lack of permission to park in the space.

In some embodiments, the vehicle can be an autonomous or semi-autonomous vehicle. The operations can include updating the one or more vehicle parking regulations based on a change of the environment such that the one or more vehicle parking regulations are specifically applicable to the environment. For example, as the vehicle travels from one town/city to the next, the vehicle parking regulations automatically update to ensure the proper regulations are considered by the system in determining compliance.

The operations can include electronically storing data indicative of the vehicle in the parked position in the space and any surrounding vehicles and structures. This data can be used to validate and reinforce that the primary vehicle was properly (or improperly) parked after other vehicles have moved or parked around the primary vehicle after some time. For example, once the primary vehicle is parked and the system indicates compliance with parking regulations, secondary vehicles may move and/or park around the primary vehicle to a point where the primary vehicle may be considered as violating parking regulations. The stored data can be used to prove to enforcement officials that the primary vehicle was indeed in compliance with parking regulations, and it was the secondary vehicles that created the noncompliance.

In another aspect, an exemplary computer-implemented method for vehicle parking compliance is provided. The method includes detecting an environment surrounding a vehicle with one or more sensors associated with the vehicle. The method includes executing instructions stored in a memory with a processing device in communication with the one or more sensors to perform operations that include generating a map of the environment based on signals received from the one or more sensors. The operations include identifying a space within the environment capable of accommodating the vehicle during a parking operation. The operations include determining if in a parked position in the space, the vehicle violates one or more vehicle parking regulations.

The operations can include electronically storing the one or more vehicle parking regulations associated with the environment in a database. The operations can include updating the one or more vehicle parking regulations based on changes to the one or more vehicle parking regulations.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for vehicle parking compliance.

FIG. 7 is a flowchart of a method for vehicle parking compliance.

FIG. 8 is a diagrammatic view of a vehicle improperly parked near an intersection.

FIG. 9 is a diagrammatic view of a vehicle properly parked near an intersection.

FIG. 10 is a diagrammatic view of an intersection with properly and improperly parked vehicles.

FIG. 11 is a flow chart of a method for vehicle parking compliance including generation of an environment map and parking space identification.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As noted above, when parking a vehicle, the general focus is on whether the selected space is capable of accommodating the size of the vehicle. However, there are other important considerations to be made, whether the vehicle being parked is an autonomous vehicle or a traditional vehicle operated by a human driver. For example, parking in a space can result in blocking of other vehicles from entering or exiting a space. As another example, the location of the parked vehicle can block turning of other vehicles at a nearby intersection due to the larger turning radius of such vehicles. In general, determination of the proper parking position is guided by local parking regulations which the driver may not be aware of. The exemplary system for vehicle parking compliance discussed herein considers such local parking regulations in identifying spaces where the vehicle can and cannot park. The system therefore avoids blocking of other vehicles, and improves the overall driving experience for all drivers.

The parking regulations can change drastically from one town to another. The system therefore maintains, updates and/or accesses the relevant parking regulations as the vehicle travels through an environment to ensure that the appropriate parking regulations are being considered when determining whether compliance is achieved. The system generates a two-dimensional (2D) or three-dimensional (3D) map of the environment around the vehicle to identify appropriate spaces for parking of the vehicle. Such scanning and generation of maps of the environment can be performed substantially continuously to ensure accuracy of operation. The system considers the general assumptions for parking regulations, as well as local legislation, local customs, and concrete location information.

When a potential space for parking is identified, the system can therefore check the relevant parking regulations and determines if parking in the location would block other larger vehicles or violate other street rules, such as distances to an intersection or no-parking zones. If a violation is determined, the system can issue an alert to the driver via a user interface to prevent parking of the vehicle. In some embodiments, the driver may be unable to put the vehicle into parking mode without acknowledging the warning on the user interface. For autonomous parking systems, the system prevents the vehicle from choosing such violating spots as options for parking, although (optionally) the user may be able to override this functionality.

In some embodiments, the system can scan the environment and determine if the vehicle (when parked) would block other passenger vehicles in a parking garage setting, for example. The system can create a log of the parked vehicle, including images around the vehicle after parking, as support/evidence that the vehicle did not violate any parking violations at the time of parking. This data can be used subsequently to prove the innocence of the vehicle owner if other vehicles park around the primary vehicle after the fact and create violations. In some embodiments, for car sharing vehicles, the system can prevent the user from ending their ride at specific locations if such locations would violate parking/stopping regulations.

The system can therefore prevent blocking of other vehicles, including, e.g., vehicles with a larger turning radius, emergency vehicles, local delivery and service vehicles, or the like. The system can prevent damage to the user's vehicle, and can prevent towing of the user's vehicle due to violations. The images captured by the system can be used in court as evidence to fight costs of unwarranted towing by showing innocence of the vehicle owner in parking. The system can be used to prevent loss of reputation for company cars or car sharing vehicles by ensuring such vehicles following local parking and/or vehicle regulations.

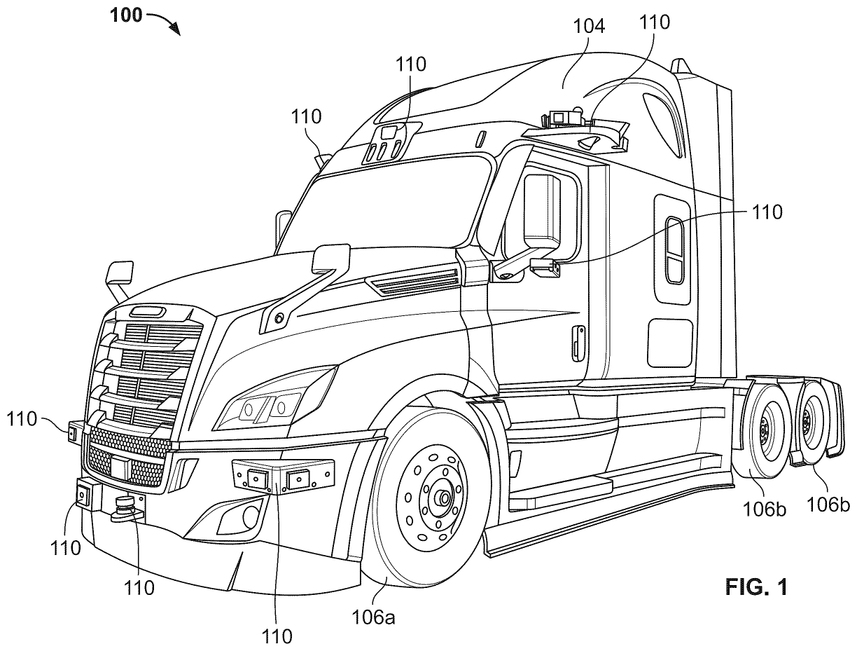

Various embodiments in the present disclosure are described with reference to FIGS. 1-11 below.

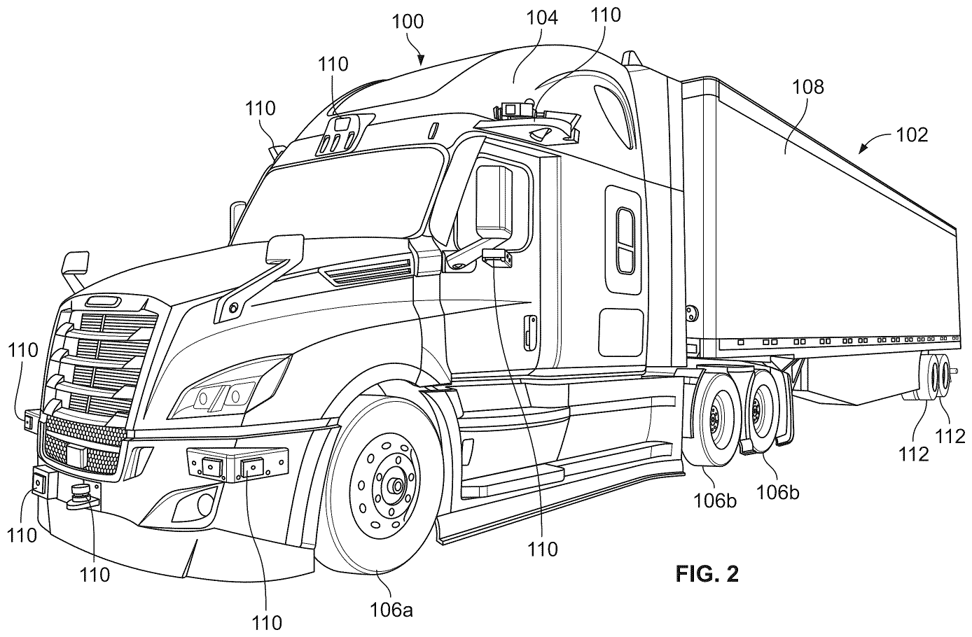

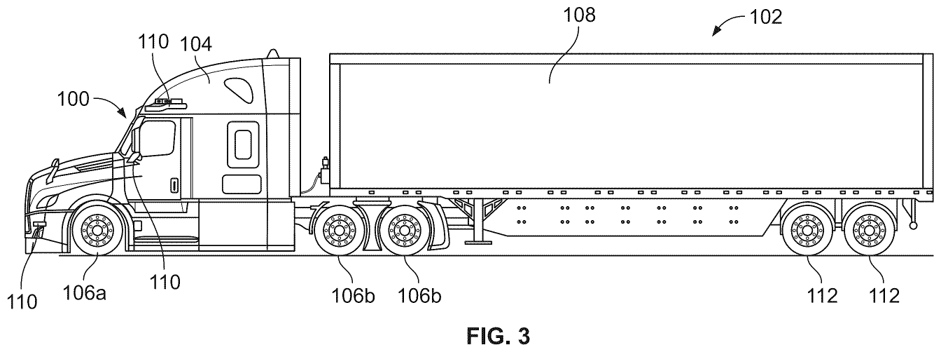

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

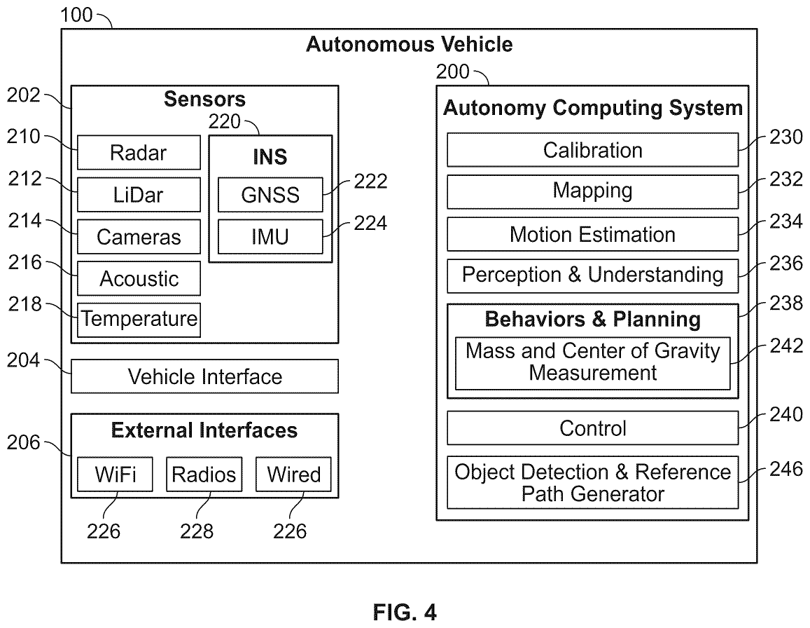

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

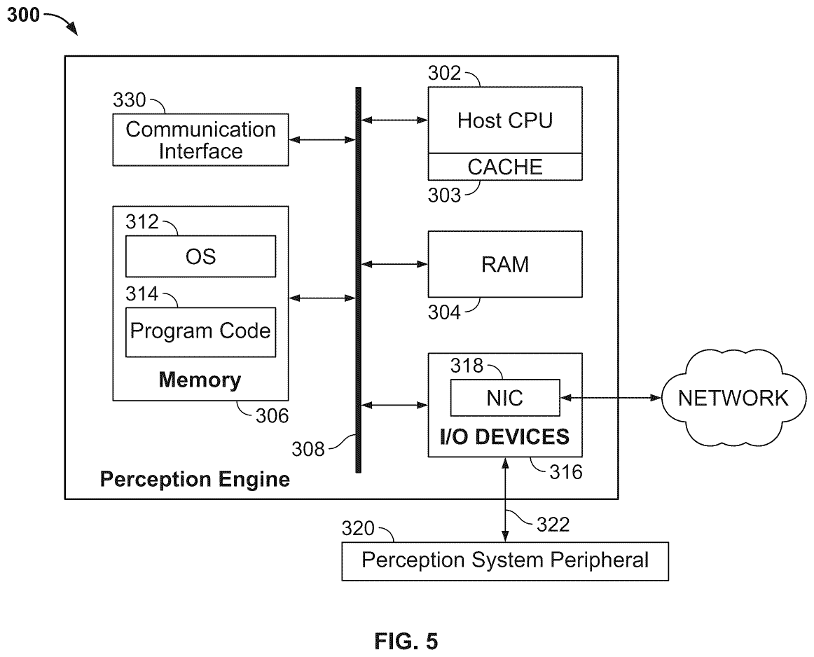

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

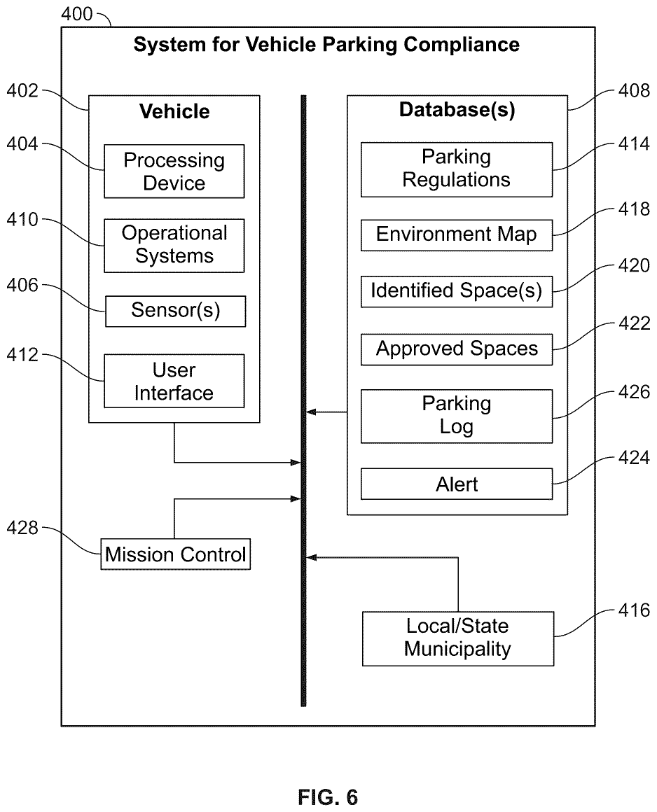

FIG. 6 is a block diagram of an exemplary system 400 for vehicle parking compliance. The system 400 generally includes one or more vehicles 402 (e.g., autonomous vehicle 100, traditional non-autonomous vehicles, semi-autonomous vehicles, or the like). Each vehicle 402 includes a processing device 404 (e.g., computing system 200, computing system 300, or the like) configured to receive and process data for determining appropriate spaces for parking of the vehicle 402 without violating parking regulations. At least some of the data received by the processing device 404 can be data from one or more sensors 406 (e.g., sensors 202). The vehicle 402 can include one or more databases 408 (e.g., memory 306) configured to receive and electronically store data. In some embodiments, the database 408 can be stored externally from the vehicle 402 and the vehicle 402 can be in communication with the external database 408 for receiving and/or transmitting data associated with the system 400.

Based on determinations made by the system 400, operational systems 410 (e.g., autonomy computing system 200) can be used to regulate operation of the vehicle 402 during the parking or no parking operation. In some embodiments, the vehicle 402 can include a user interface 412 (e.g., a graphical user interface) configured to output information to the user/driver. In some embodiments, the user interface 412 can be associated with a mobile device of the user/driver, e.g., a smart phone, or the like.

The database 408 electronically stores and/or is capable of electronically accessing up-to-date parking regulations 414 for various local and state jurisdictions. In some embodiments, the local/state municipalities 416 can be in communication with the system 400 via a communication network such that the regulations 414 remain up-to-date as the vehicle 402 travels through an environment. Thus, as the vehicle 402 travels from city to city, the city-specific regulations 414 can be considered in determining whether the vehicle 402 is able to park in certain areas. The most relevant regulations 414 are therefore considered by the system 400 to ensure full compliance of the vehicle 200.

As the vehicle 402 travels along a road, the sensors 406 are used to digitally capture images of the environment around the vehicle 402 to generate an environment map 418. The map 418 can be either 2D or 3D, and provides the system 400 with information regarding other vehicles and objects located in the environment, as well as nearby intersections. In some embodiments, the environment map 418 can be generated by the system 400 at all times. In some embodiments, the environment map 418 can only be generated by the system 400 when the vehicle 402 reaches and remains beneath a predetermined speed threshold for a period of time (e.g., under 25 mph for more than 30 seconds, or the like). The system 400 can therefore use the speed of the vehicle 402 to estimate that the vehicle 402 is searching for a parking space (e.g., entering a “parking mode” operation), and only generates the environment map 418 in such instances to avoid unnecessary operations.

In some embodiments, the system 400 can rely on an estimated time of arrival value (e.g., if the vehicle us using a global positioning system (GPS) with directions to a destination) to initiate generation of the environment map 418. For example, if the estimated time of arrival value is less than a predefined threshold (e.g., below 5 minutes, below 4 minutes, below 3 minutes, below 2 minutes, below 1 minute, or the like), the system 400 can begin generation of the environment map 418. In some embodiments, the predefined threshold for the estimated time of arrival value can be dependent on the type of environment in which parking is to be found (e.g., a greater value if the destination is within an environment in which parking is difficult to locate). The estimated time of arrival value can be configurable or selectable by the user. In some embodiments, the system 400 can generate the environment map 418 based on information received from the GPS or navigation system, e.g., that the vehicle is located in a predefined area. In some embodiments, the user/driver can indicate via the user interface 412 that parking is desired, and the system 400 can begin generating the environment map 418 upon such input request.

The environment map 418 allows the system 400 to determine if there are obstacles or vehicles that could prevent parking of the vehicle 402 in a manner that complies with the regulations 414, or if the vehicle 402 would be too close to an intersection and would prevent turning of other vehicles (as non-limiting examples). In the environment map 418, the system 400 identifies spaces 420 capable of accommodating the size of the vehicle 402. The system 400 correlates the details of the environment map 418 with the parking regulations 414 to determine which of the identified spaces 420 are capable of receiving the vehicle 402 without violating the regulations 414. The correlation between the regulations 414, map 418, and spaces 420 therefore allows the system 400 to narrow the list of identified spaces 420 to those identified spaces that are approved spaces 422 for parking, i.e., spaces that do not violate any of the regulations 414.

If a space 422 is identified, the system 400 can generate an alert 424 to the user/driver via the user interface 412 indicating the location of the space 422 and the compliance with all regulations 414. If a space 420 is determined to fail compliance with one or more regulations 414, the system 400 can also generate an alert 424 with this information to the user via the user interface 412 to prevent parking of the vehicle 402 in such space. For non-autonomous vehicles, the user interface 412 can include an option to override the alert 424, with the system 400 storing in the database 408 the fact that the user bypassed the alert 424 and recommendation from the system 400. For autonomous vehicles 402, any non-compliant spaces are automatically removed from consideration and the autonomous vehicle 402 cannot attempt to park in such spaces. Instead, only approved spaces 422 are considered by the autonomous vehicle 402. In some embodiments, the data associated with approved spaces 422 and the decision to park the vehicle 402 can be transmitted to a remote mission control 428 to assist with operation of the autonomous vehicle 402, if needed.

After the vehicle 402 has parked in the approved space 422, the system 400 can capture data indicative of the environment around the parked vehicle 402. Such environmental data can include, e.g., surrounding vehicles, street signs, distances from intersections, or the like. This data can be electronically stored as a parking log 426, which can be available for reference if proof of regulation 414 compliance is needed in the future. For example, at the time of parking the vehicle 402 in the approved space 422, all regulations 414 may be in compliance. However, after parking, other vehicles may park around the vehicle 402, resulting in non-compliance of certain regulations 414. The parking log 426 can be used to prove the innocence of the driver of the vehicle 402 if, e.g., the vehicle 402 is towed, showing that other vehicles created the non-compliance after the fact. In some embodiments, after the vehicle 402 parks, the sensors 406 can continue to create the environment map 418 and store data around the vehicle 402 to capture when the non-compliance issue occurs after the original parking of the vehicle 402. Such data can be used in the parking log 426 to illustrate exactly when the non-compliance occurred and the cause of such non-compliance.

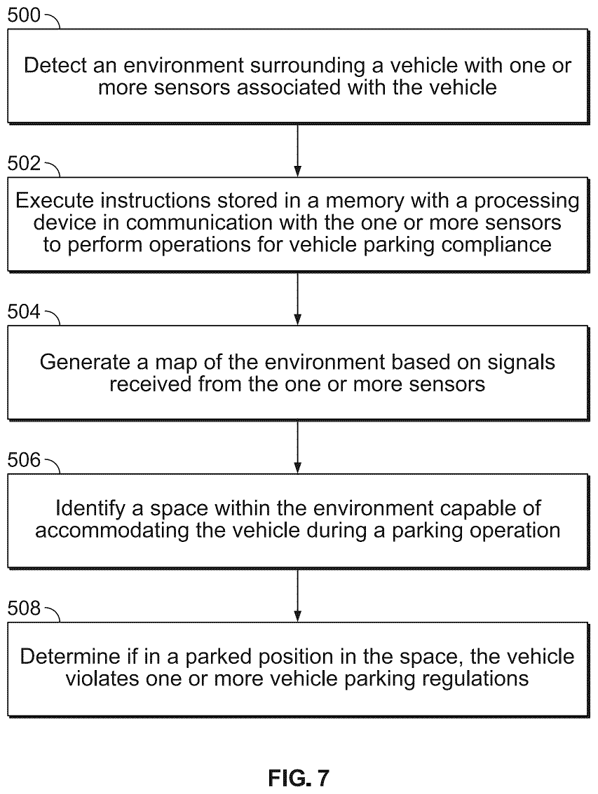

FIG. 7 is a flowchart of a method of vehicle parking compliance by the exemplary system 400 discussed herein. At 500, an environment surrounding a vehicle is detected with one or more sensors associated with the vehicle. At 502, a processing device executes instructions stored in a memory to perform operations for vehicle parking compliance. At 504, a map of the environment is generated based on signals received from the one or more sensors. At 506, a space within the environment capable of accommodating the vehicle during a parking operation is identified. At 508, a determination is made if in a parked position in the space, the vehicle would violate one or more vehicle parking regulations. Based on this determination 508, the system can decide if the vehicle is permitted to park in the identified space or if another space should be found.

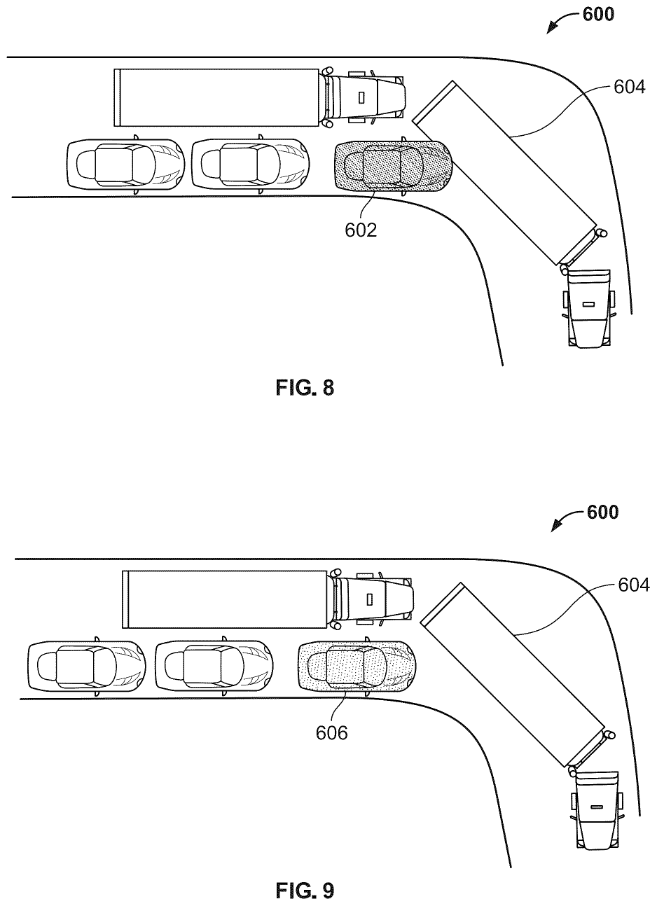

FIGS. 8 and 9 are diagrammatic views of an intersection 600 around which vehicles are parked. In particular, FIG. 8 is a view of the intersection 600 with a vehicle 602 parked too close to the intersection 600, resulting in the vehicle 602 impeding a truck 604 from successfully turning at the intersection 600. Due to the relatively large turning radius of the truck 604, the vehicle 602 parked proximate the intersection 600 is positioned in the turning path of the vehicle 602. As a result, the vehicle 602 will prevent the vehicle 604 from successfully completing the turn at the intersection 600. The vehicle 602 violates parking regulations for this intersection 600, and as a result, the vehicle 602 parked in violation can incur damage from the contact with the turning truck 604, impede traffic through the intersection, or create logistical issues, for example.

In contrast, FIG. 9 shows a vehicle 606 parked at a distance offset from the intersection 600. This offset distance is in compliance with parking regulations and provides sufficient clearance for other vehicles, including the truck 604, to successfully complete turns at the intersection 600. The exemplary system discussed herein is intended to prevent parking in a manner that violates the local regulations (such as the vehicle 602), and only allows vehicles like truck 604 to park in a manner that complies with the local regulations (such as the vehicle 606).

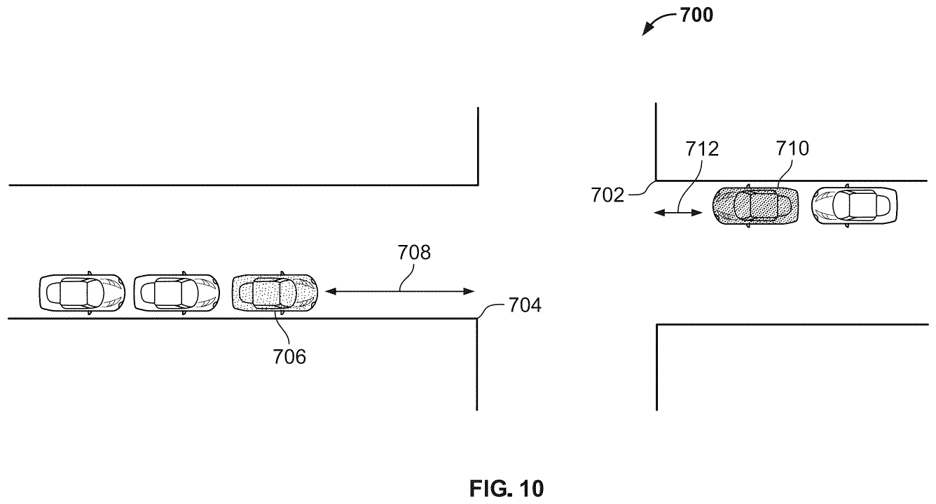

FIG. 10 is another diagrammatic view of an intersection 700, illustrating vehicles parked in compliance and violating local parking regulations. The intersection 700 includes corners 702, 704 from which the offset parking distance is measured in order to provide sufficient clearance for other vehicles to turn at the intersection 700. As an example, the minimum distance from the corners 702, 704 can be, e.g., about 5 meters, to avoid collisions with turning vehicles. The vehicle 706 is parked at an appropriate and in-compliance distance 708 from the corner 704. In contrast, the vehicle 708 is parked at a distance 712 from the corner 702 that is shorter than distance 708, and is therefore in violation of the local parking regulations. Because the parking regulations can vary from city to city, the system considers such parking regulations and ensures that the proper distances are used when parking the vehicle to avoid blocking of intersections for others.

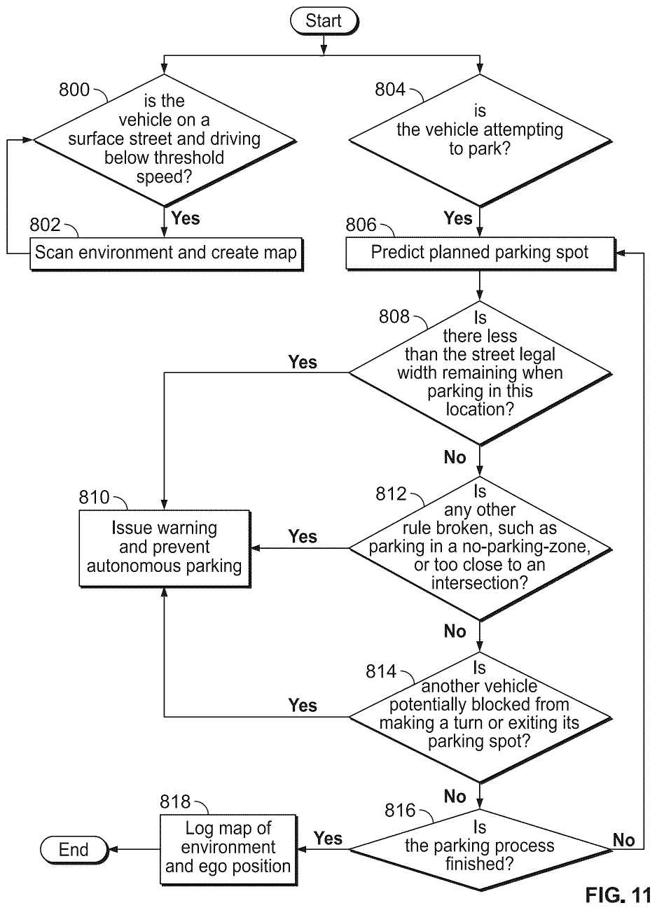

FIG. 11 is a flow chart of an exemplary method for vehicle parking compliance performed by the exemplary system 400 discussed herein. In some embodiments, at 800, the system can determine if the vehicle is traveling on a surface street and driving below a threshold speed. In such embodiments, the system relies on the vehicle speed to estimate whether the vehicle is attempting to find a parking space. If yes, at 802, the system can begin scanning the environment and creating a 2D or 3D map. In some embodiments, rather than monitoring the speed of the vehicle, at 804, the system can rely on, e.g., information received from a navigation or GPS system associated with the vehicle indicating an estimated time of arrival to the destination or that the vehicle is located within a predefined area, to determine if the vehicle is attempting to park. If yes, at 806, the system predicts a planned parking spot for the vehicle. In such embodiments, scanning of the environment and creating a map can occur at 804 to identify the parking spot.

At 808, the system determines if there is less than the street legal length and/or width remaining when parking in the selected location. If yes, at 810, the system issues a warning and prevents the autonomous vehicle from parking. If the vehicle is non-autonomous, the system can still issue a warning and the driver can either abide by the warning or override the warning via the user interface. If the answer at 808 is no, at 812, the system determines if any other rule is broken, such as parking in a no parking zone or parking too close to an intersection. If yes, again at 810, a warning is issued to the driver or the autonomous vehicle is prevented from parking. If the answer at 812 is no, at 814, the system determines if another vehicle is potentially blocked from making a turn or existing its parking spot based on the intended position of the vehicle. If yes, again at 810, a warning is issued to the driver or the autonomous vehicle is prevented from parking.

If no, the vehicle is allowed to park in the space and, at 816, a determination is made whether the parking process is completed. If no, the process can return to 806 to locate and identify a parking spot in which the vehicle can park. If the parking process is complete, at 818, the system can create a log map of the environment and the vehicle position. The log map provides information showing compliance of the vehicle with all parking regulations, providing data that can be used to support the innocence of the driver/vehicle if subsequent vehicle actions result in violations. The log therefore provides documentation which can be used as a defense to the vehicle owner, if needed.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for vehicle parking compliance, comprising:
one or more sensors associated with a vehicle, the one or more sensors configured to detect an environment surrounding the vehicle; and
a processing device in communication with the one or more sensors, wherein the processing device is configured to execute instructions stored in a memory to perform operations comprising:
generating a map of the environment based on signals received from the one or more sensors;
identifying a space within the environment capable of accommodating the vehicle during a parking operation;
determining if in a parked position in the space, the vehicle violates one or more vehicle parking regulations.

2. The system of claim 1, comprising a database configured to electronically store the one or more vehicle parking regulations associated with the environment, and the operations further comprise updating the one or more vehicle parking regulations based on changes to the one or more vehicle parking regulations.

3. The system of claim 1, wherein the one or more vehicle parking regulations include a minimum distance from a corner of an intersection.

4. The system of claim 1, wherein the one or more vehicle parking regulations include an unlawful obstruction of other vehicles.

5. The system of claim 1, wherein the one or more vehicle parking regulations include an unlawful obstruction for pedestrians.

6. The system of claim 1, wherein the one or more vehicle parking regulations include a no parking zone.

7. The system of claim 1, wherein the map is a two-dimensional (2D) map of the environment.

8. The system of claim 1, wherein the map is a three-dimensional (3D) map of the environment.

9. The system of claim 1, wherein generating the map of the environment comprises continuously generating the map of the environment as the vehicle travels through the environment.

10. The system of claim 1, wherein identifying a space within the environment comprises determining a minimum space requirement between the vehicle and (i) surrounding vehicles and/or (ii) an intersection corner.

11. The system of claim 1, wherein the one or more sensors include at least one of LiDAR, a camera, radar, or an ultrasonic sensor.

12. The system of claim 1, wherein if in the parked position in the space the vehicle does not violate the one or more vehicle parking regulations, the operations comprise permitting the vehicle to park in the space.

13. The system of claim 1, comprising a user interface including a display.

14. The system of claim 13, wherein if in the parked position in the space the vehicle does not violate the one or more vehicle parking regulations, the operations comprise generating a parking permission alert on the display of the user interface.

15. The system of claim 13, wherein if in the parked position in the space the vehicle violates the one or more vehicle parking regulations, the operations comprise generating an alert on the display of the user interface regarding a lack of permission to park in the space.

16. The system of claim 1, wherein the vehicle is an autonomous vehicle.

17. The system of claim 1, wherein the operations comprise updating the one or more vehicle parking regulations based on a change of the environment such that the one or more vehicle parking regulations are specifically applicable to the environment.

18. The system of claim 1, wherein the operations comprise electronically storing data indicative of the vehicle in the parked position in the space and any surrounding vehicles and structures.

19. A computer-implemented method for vehicle parking compliance, comprising:
detecting an environment surrounding a vehicle with one or more sensors associated with the vehicle; and
executing instructions stored in a memory with a processing device in communication with the one or more sensors to perform operations comprising:
generating a map of the environment based on signals received from the one or more sensors;
identifying a space within the environment capable of accommodating the vehicle during a parking operation; and
determining if in a parked position in the space, the vehicle violates one or more vehicle parking regulations.

20. The computer-implemented method of claim 19, comprising electronically storing the one or more vehicle parking regulations associated with the environment in a database, and updating the one or more vehicle parking regulations based on changes to the one or more vehicle parking regulations.
